(19) United States
(12) Patent Application Publication
(10) Pub. No.: US 2017/0243193 A1
(43) Pub. Date: Aug. 24, 2017

(54) HYBRID BLOCKCHAIN

(71) Applicant: SkuChain, Inc., Mountain View, CA (US)

(72) Inventors: Zaki N. MANIAN, Los Altos Hills, CA (US); Ranganathan KRISHNAN, San Jose, CA (US); Srinivasan SRIRAM, Mountain View, CA (US)

(21) Appl. No.: 15/212,018

(22) Filed: Jul. 15, 2016

Related U.S. Application Data
(60) Provisional application No. 62/297,107, filed on Feb. 18, 2016.

(51) Int. Cl. G06Q 20/24; G06Q 20/38

(52) U.S. Cl. CPC G06Q 20/24; G06Q 20/3829; G06Q 2220/00

(57) ABSTRACT

This disclosure describes a hybrid of blockchain with other information management systems to provide validation for documents, transaction state and performance against contracts. A blockchain document hybrid allows portions of versioned documents to be shared without revealing full document content. For transaction and contract state a confidential Shared Data Structure (SDS) is combined with a publicly viewable blockchain to record the terms of a trade transaction, starting from as early as a purchase order. Out of these building blocks we present designs for commerce systems that can automatically execute the flow of money based upon signals resulting from the flow of goods. Besides reducing processing costs through automation, these designs open up avenues for innovations such as a Data LC, Blockchain Based Obligation (BBO), Deep Tier Financing, and Cash Flow Scrips.

### CROSS REFERENCE TO RELATED APPLICATIONS

This application claims priority to U.S. provisional patent application Ser. No. 62/297,107 filed Feb. 18, 2016, which is incorporated herein in its entirety by this reference thereto.

### FIELD

The invention relates to a blockchain technology. More particularly, the invention relates to a hybrid of blockchain with other information management systems to provide proof of validity of documents, validity of the state of transactions, and validity of performance against contracts.

### BACKGROUND

Trade and Commerce between buyers, sellers, and financiers are conducted through the use of a few well-known instruments such as Purchase Orders, Invoices, Bank Guarantees, Obligations, Insurance certificates, Letters of Credit, Bills of Lading/Logistics documents, etc. These instruments are used by financiers to provide working capital financing, invoice discounting, and related financing to the parties involved.

### Document Validity

The authenticity of these documents, the inability to duplicate those documents that convey title, and the ability to validate the present state (given the possibility of documents being revised or superseded) are all critical pieces of information that financiers need.

Electronic information systems have not yet provided the validation features required in a convenient and secure way to allow commercial documents to become fully electronic. Rather, paper-based process flows are still the norm in large part because the electronic systems are not seen as providing improvement on the security of paper-based process flows.

For example, Letter of Credit (LC) processing is still today largely paper based, even though efforts at electronification started as early as 2001 with publication of the eUCP rules for electronic presentation of documents. The following discussion describes some of the reasons for the limited adoption of electronification.

One hears from trade finance professionals that while a bank may be reluctant to issue an LC under eUCP, the same bank may be happy to take an advising role in an LC issued under eUCP. This anecdote gets to the core of why electronification of LCs has not progressed. An issuing bank needs to be assured of the security of the electronic presentation process before it is willing to issue an LC under eUCP. The advising bank on the other hand does not bear liability if there is any fraud or irregularity in the documents presented under eUCP. The advising bank only see benefits because eUCP reduces the bank's work burden and allows it to get the presented documents to the issuing bank instantaneously and thereby speed up the settlement of funds.

The security of electronic documents has two aspects in the context of trade finance. The first is having confidence in document integrity, current validity, and confidence that the document has been issued by the right party. The second has to do with ensuring non-duplication of documents that serve as title to assets, e.g. an invoice, a bill of lading, etc. Increasing electronification in trade finance requires robust, easy to use, and standardized systems that ensure such document security. The eUCP guidelines are not specific about how such security is to be achieved and leave it to the issuing bank to determine procedures that are acceptable to the bank. This places a large burden on the issuing bank and has resulted in banks continuing with paper-based processes that they understand, rather than adopting new electronic processes whose security they are uncertain about. Further, because there is no standard for electronic presentation, the other banks may not support the presentation method required by an issuing bank, further limiting issuance of LCs under eUCP.

### Enhanced Features

Electronic systems have not provided the enhanced features commercial participants need. One of the challenges for parties involved with such commercial documents is the need to manage these documents efficiently and securely through their entire lifecycle. For example documents may originate from a single party, but then must be confirmed by one or more other parties. The confirmation must be recorded in a way that the documents themselves can be living in the sense that they go through revisions based on discussions between the parties. Keeping track of the current, agreed upon version can be a vexing task for the parties involved.

The documents also must be shared with other participants who may not be party to an agreement. Moreover, that sharing must be done selectively in that only a portion of the document is to be shared, while the remainder of the document must be kept private. The participant viewing a portion of a shared document however must be assured that what they are viewing is authentic, even though they are not able to view the full document. Electronic systems have not provided these features in a convenient and secure way.

### Consistent Transaction and Contract State

Commercial documents record the business intent of parties and contracts between parties. There is also a need for commercial parties to keep track of performance against such business intent and contracts. Such performance state, when maintained by parties on their own separate information management systems, creates a risk of the performance state being inconsistent across different parties. Such inconsistent performance state is not only problematic to the parties in a transaction or contract but also is commercially relevant to parties that may not be part of a transaction. For example, in a trade transaction between a buyer and a seller the transaction status is relevant to a financier that is not originally part of the transaction if the financier is evaluating a provision of financing either to the buyer or the seller. There is therefore a need to have a shared information system across commercial parties, e.g. buyer, seller, and financier, to maintain transaction and contract performance state. Moreover, each of the parties should be able to ascertain the validity of the state reported by the shared information system to have the confidence to make business decisions.

Maintaining commercial documents separate from the state of transactions and contracts slows down processing and places additional costs on the parties to reconcile state with documents. Consequently, there is need for shared information system across commercial parties that integrates the state of transactions and contracts with commercial documents to increase efficiency and reduce processing errors and costs.

### Adoption Challenge

Even if an electronic system were to provide all of the features that commercial participants need, it can run into an adoption challenge. In general, if adoption of a technology requires that two or more parties to a transaction adopt it, then bootstrapping the eco-system into the technology is slow or never happens. Because prior attempts at electronification of LCs were aimed at replacing the paper process with an all electronic process, adoption by all parties was required for the benefits to be realized. This has significantly slowed down adoption.

Another important reason for slow adoption has been the complexity. Bolero and BPO are attempts at electronification of LCs that have met with limited success because of the complexity. Moreover, not just the banks but also the LC customers (Buyer and Seller) were required to adopt those technologies. Because the burden of adoption was high, even if banks would adopt, their LC customers still shy away from adoption.

### SUMMARY

### Trade Finance, Trade Instruments, and the Blockchain

In connection with embodiments of the invention, the benefits of blockchain technology can be described in terms of three commercially relevant functions that blockchains can provide: Notarization, Title, and Provenance/Chain of Custody.

For notarization the tamper proof nature of a blockchain allows it to not only to attest to the authenticity and integrity of declarations by participants, but also allows it to offer something heretofore unavailable: proof of non-existence of such declarations. Blockchain notarization is additionally more forgery resistant than paper notarization.

For title, cryptographic identifiers can be used for goods or physical assets, and authoritative title records maintained in the blockchain. The double spend resilience provided by blockchains guarantees the consistency of title history, ensuring that there is a unique title holder at any given point in time.

For provenance and chain of custody, cryptographic identifiers for items can hold item origin and history of custody in a way that allows sub-division and combination of items.

### Hybrid Blockchain Document

To realize these commercially relevant functions in real world systems embodiments of the invention create hybrids of a blockchain with existing electronic document management systems. The blockchain records commitments to documents, portions of documents, and changes to documents by the authors via their electronic signatures recorded in an immutable way in the blockchain. The document content itself is stored in existing document management systems. A hybrid created in this way allows parties that are provided access to a document or portion of a document to ascertain document validity using the blockchain.

Specifically, as discussed above, a distributed ledger/blockchain allows for the notarization of agreements between parties without need for an intermediating trusted party. This application of blockchain can be used to manage complex agreements between parties, such as those that occur in commerce and trade. In particular, hybrid blockchain technology allows buyers, sellers, and financiers to generate independently verifiable proof that an invoice or purchase order is a valid receivable asset though the system.

Embodiments of the invention recognize that the advent of blockchain technology holds the possibility of significant advances in collaborative commerce. Embodiments of the invention are built upon the insight that trust in the data recorded in blockchains allows automation of high value steps in commerce that currently require human review, and facilitates automated compliance for complex contracts between participants who have not developed a prior trust relationship. By providing such trust, without introduction of new trusted intermediaries, blockchain technology represents a great leap forward in efficiency and cost-effectiveness.

In embodiments of the invention, hybrid blockchain technology is used to ensure that fraud and duplication are impossible in financial transactions involving various instruments, as well as to ensure that the ownership and title of these instruments are securely registered on a distributed ledger.

### Hybrid Blockchain Transaction and Contract State

Embodiments of the invention create hybrids of a blockchain with information systems that maintain shared transaction and contract state across commercial parties. A hybrid created in this way allows the parties to validate the transaction and contract state independently using the blockchain. Moreover, such a hybrid system maintains privacy and allows the parties to control to whom they reveal contract state.

### Hybrid Blockchain Integrated Document and Transaction/Contract State

Embodiments of the invention create hybrids of a blockchain with integrated information systems that combine document management with maintenance of shared transaction and contract state across commercial parties. Such systems allow parties to validate the information presented by the system using the blockchain. Moreover, these systems maintain the requisite information privacy allowing parties to control who can view a portion of a document or a specific transaction or contract performance act.

### Extended Hybrid Embodiments

In addition to creating hybrids of blockchain with existing document management and shared information management systems, embodiments of the invention create extended hybrids of blockchain with other existing systems, such as the SWIFT message network used to process LCs. This is done to allow electronic document presentation needed in LC processing to be integrated into the SWIFT messaging flow. Another reason for such an extended hybrid embodiment is to solve the adoption challenge described earlier. Specifically, the blockchain/LC hybrid embodiment described in detail below, allows a bank that has adopted blockchain technology to derive benefits from the technology even when working with a counterparty bank in the LC transaction that has not adopted blockchain technology.

### DRAWINGS

FIG. 1 shows the steps in a work flow according to the invention;

FIG. 2 shows a Purchase Order Document Proof according to the invention;

FIG. 3 shows a Mod (AKA Supercede) Purchase Order Element according to the invention;

FIG. 4 shows a Purchase Order with Addition according to the invention;

FIG. 5 is a verification diagram showing a request for a Root Object and Purchase Order according to the invention;

FIGS. 6A-6C show e-presentation logistics (FIG. 6A), a letter of credit (FIG. 6B), and a commercial invoice (FIG. 6C) according to the invention;

FIGS. 7A-7C show examination logistics (FIG. 7A), a letter of credit (FIG. 7B), and a commercial invoice (FIG. 7C) according to the invention;

FIG. 8 shows a shared data structure (SDS) for a data LC according to the invention; and

FIG. 9 is a block diagram of a computer system as may be used to implement certain features of some of the embodiments.

### DESCRIPTION

### Blockchain/Distributed Ledger

A blockchain is a distributed database that maintains a continuously-growing list of data records hardened against tampering and revision through a byzantine fault tolerant consensus protocol. It consists of data structure blocks, with each block holding batches of individual transactions and the results of any blockchain executables. Each block is part of numbered sequence and contains information linking it to a previous block. Thus, the blockchain consists of blocks that hold batches of valid transactions. Each block includes the hash of the prior block, thus linking the blocks together. The linked blocks form a chain, with each additional block reinforcing those before it, thus giving the database type its name.

As such, a blockchain is a digital ledger that records every transaction that has ever occurred. It is protected by cryptography so powerful that breaking it is typically dismissed as impossible. More importantly, though, the blockchain resides not in a single server, but across a distributed network of computers. Accordingly, whenever new transactions occur, the blockchain is authenticated across this distributed network, then the transaction is included as a new block on the chain.

A blockchain implementation consists of two kinds of records: transactions and blocks.

Transactions are the content to be stored in the blockchain. Transactions are created by participants using the system. In the case of crypto-currencies, a transaction is created any time a crypto-currency owner sends crypto-currency to someone. System users create transactions that are passed from node to node on a best-effort basis. The system implementing the blockchain defines a valid transaction. In crypto-currency applications, a valid transaction must be digitally signed, spend one or more unspent outputs of previous transactions, and the sum of transaction outputs must not exceed the sum of inputs.

Blocks record and confirm when, and in what sequence, transactions enter and are logged in the blockchain.

### Shared Data Structures (SDSs)

In embodiments of the invention, the terms of a trade transaction, starting as early as the purchase order, are recorded in a smart contract referred to as a shared data structure (SDS), also referred to as a BRACKET data structure. An SDS smart contract records performance by parties against the agreed upon terms and can also automatically execute the flow of money based upon signals resulting from the flow of goods. The SDS as described herein maintains shared information across the commercial parties in the transaction.

In this disclosure, the term SDS is a short hand reference to hybrid of a blockchain with a shared information system that defines and maintains shared contract state across parties and optionally integrates the commercial documents used by transaction parties. The use of the term SDS is not meant to limit the scope of this disclosure to embodiments or realizations that use the term SDS to refer to such hybrid blockchain shared information systems.

Besides reducing processing, SDSs open up avenues for innovations in finance, such as a Data LC, Blockchain Based Obligation (BBO), Deep Tier Financing, and Cash Flow Scrips.

The Data LC speeds up payment to customers while providing processing efficiency for banks in the transaction. Through integration with SWIFT rails for LCs the Data LC addresses the adoption challenge for new technology. Specifically, the Data LC allows a SDS-aware bank to accrue benefits even when the counter party is not SDS-aware. The BBO provides a purely blockchain based means for a bank to take on a payment obligation, contingent on trade requirements being met. With the Data LC and the BBO, a SDS-aware bank can generate new revenue from financing Open Account users. Specifically, for the bank's customers who are suppliers, use of the Data LC enables them to avail better financing opportunities. For the bank's customers who are buyers, use of the BBO allows their suppliers to secure improved financing from the bank.

SDSs also facilitate Deep Tier Financing, which allows a highly credit worthy buyer to lower the cost of capital through the tiers of their supply chain. This reduces the cost of goods for the buyer while simultaneously allowing the buyer to have deep visibility into their supply chain. SDSs provide an implementation of Cash Flow Scrips which are Banker's Acceptances that can be transferred on the blockchain and enable many interesting applications, including Deep Tier Financing.

### Trade Proofs for Commercial Documents

Embodiments of the invention provide an electronic system that manages commercial documents using the notarization functionality provided by a distributed ledger/blockchain. A document is represented as consisting of elements. For example, a purchase order might contain such elements as description of goods, issuance date, amount, etc. Assent to the elements is recorded by one or more parties using a cryptographic commitment recorded on the distributed ledger/blockchain. Such a commitment is referred to as an ElementProof. To allow documents to be living, elements are allowed to be revoked or superseded by the parties that are attesting to a document. To allow sharing, the element content to be shared is provided and the Element Proof is pointed to, to provide authentication of the content that has been shared. For example, this would allow sharing of the purchase order (PO) amount without sharing any other elements in the PO.

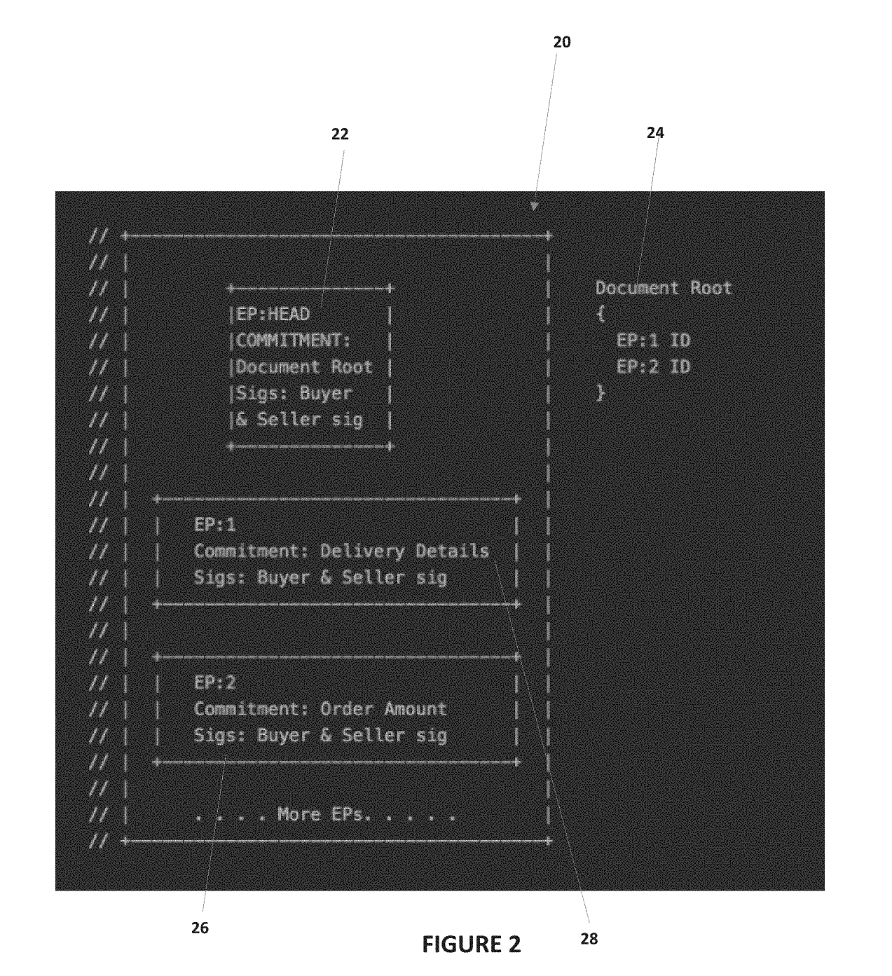

Diagrams describing the data structure used in embodiments of the invention are shown in FIGS. 2-4, which illustrate this using a Purchase Order document as an example. However, the schemata can be applied to any commercial document. When any portion of a Purchase Order (PO) is shared with a new party, the following verifications can easily made against the data:
The data is approved by all of the parties;
The terms are current and have not been superseded by a more recent version; and
Privacy of underlying business data.

Embodiments of the invention make extensive use of cryptographic commitments to data held on other systems. Cryptographic commitments have two key properties: They hide the information committed to and they bind to that information, such that only the original information stored in those other systems can satisfy the commitment. A document is considered to consist of several elements. The commitment to a document consisting of such elements is made up of distinct components inside a distributed ledger referred to herein as Element Proofs (EPs).

FIG. 2 shows a Purchase Order Document Proof 20 according to the invention. The Document Proof includes a Document Root 24, an EP Head 22, and one or more EPs 26, 28. When a modification is sent, a set of transactions introduces a superseding proof element 26 into the ledger. Anyone with an outdated proof sees that the terms have been changed.

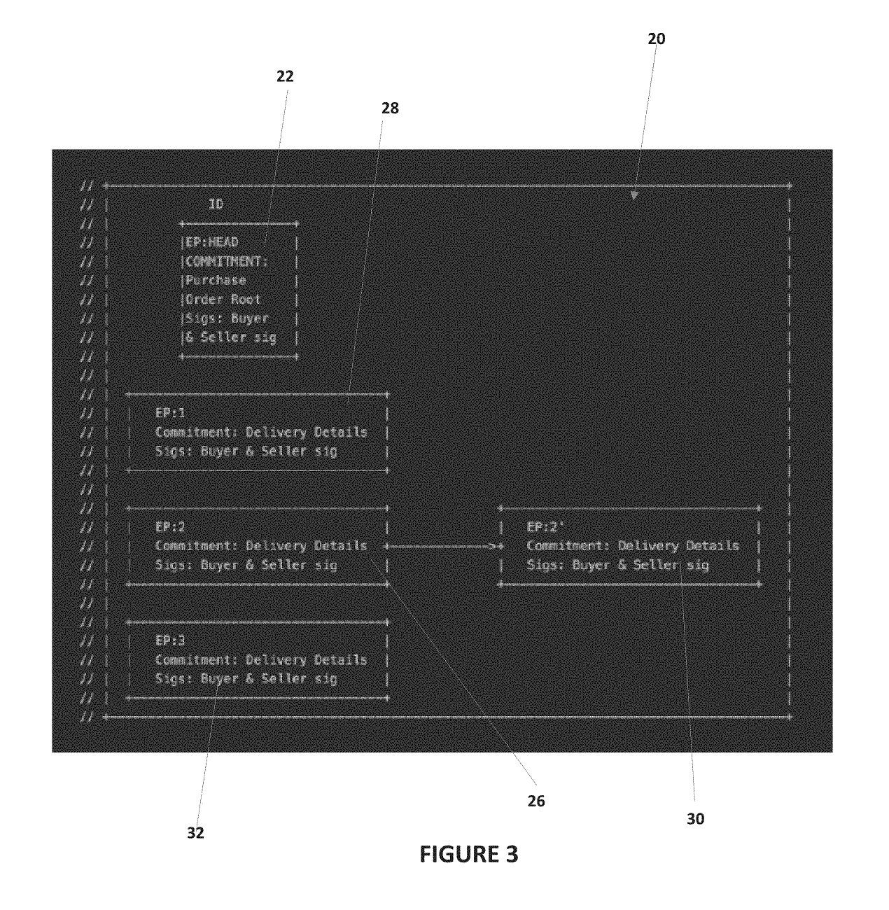

FIG. 3 shows a Mod (AKA Supercede) Purchase Order Element according to the invention. In FIG. 3, EP: 2 26 is modified to EP:2 30; a further EP 32 is also shown in FIG. 3.

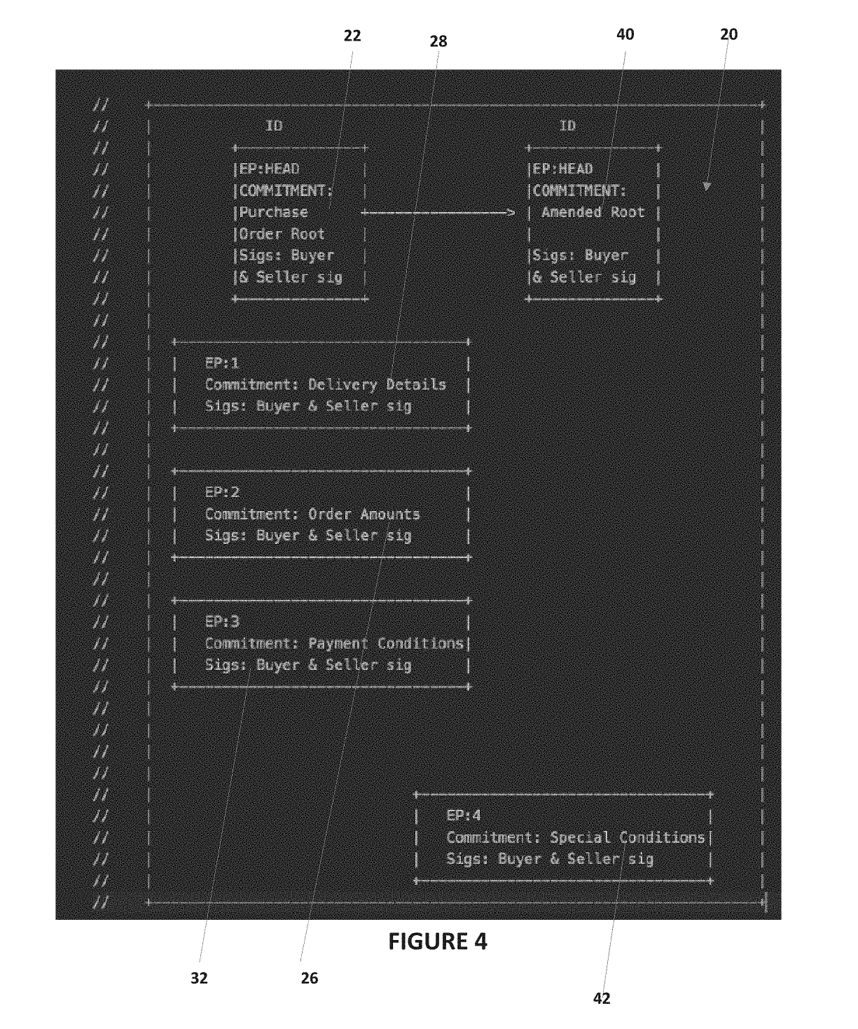

FIG. 4 shows a Purchase Order with Addition according to the invention. If a new Proof element 42 is introduced in to a Purchase Order Proof, the Head element 40 is updated to include a commitment to the new proof element.

### Identities in Trade Proofs

The system must prevent unauthorized parties from using publicly available blockchain data to infer commercially relevant information (“blinding”), such as the identities of other counter parties in the system. Embodiments of the invention maintain a publicly viewable record of a long term identity key for a particular entity on the system. This identity may be signed by a Certificate Authority to provide a connection to a real world identity.

This imposes the requirement that public keys used on the ledger be computationally unlinkable to the identities used on the chain. This creates two categories of users of the chain. The first category are users that have access to the SDS and thus can link signatures on the ledger to publicly observable identities. The second category only has access to the public ledger and cannot link identities to the signatures on the ledger.

### Identity Keys Used by Participants in the System:

Identity Keys are the public key in a (PublicKey, PrivateKey) elliptic curve cryptography key pair. The authentic holder of the identity can generate a set of signatures that is only linkable to their keypair through the knowledge of a nonce, N. To generate a signature, the signer generates a new PublicKeyN using PublicKey.Derive(N) then does Sign(PrivateKey, N, message). PublicKeyN and the signature are then published. The nonce cannot be feasibly computed from the published data. A verifier who wishes to link the identity first verifies the signature with verifySig(PublicKeyN,signature,message). They can then obtain the nonce, N from the SDS data structure and verify that PublicKeyN=PublicKey.Derive(N).

The SDS contains a UUID for each element. For instance, the total amount field of a purchase order is an individual element with a UUID. All parties required to assent to this field of the document have a unique unlinkable public key derived for the Trade Proof. These keys are generated by taking the hash of the UUID and treating the resulting output as 256 bit integer. This integer is now multiplied by the Base Point of an Elliptic Curve chosen by the SDS-based protocol. The resulting Elliptic Curve Point is added to the Public Keys of each of the signatories. This creates a unique identity bound to the Trade Proof for this element of the SDS. When each signatory signs the trade proof, they transform their Private Key by taking the hash of the UUID as an integer, performing modular arithmetic with their Private Key, and then running a standard elliptic curve signature algorithm with the sum of these two values.

SDS Nonces are generated by cryptographically hashing (Sha256) the UUID values with the SDS. These values have must have sufficient degrees of freedom (at least 160 bits) that they cannot be predicted by observers who do not have access to SDSs.

The parties to a transaction have access to the SDS, including all the UUIDs for each ledger entry. The parties can link the signatures used in the ledger to both the certificated identities and to a specific element identified by a UUID in the SDS.

### Encrypted Data in the Ledger

Many pieces of data that might need to be verified against the distributed ledger fall within well-defined ranges. For instance, the total in purchase order might be a field validated with a trade proof. Because a competitor might simply search the ledger for collisions with different purchase order totals additional masking is required before the data is notarized in a trade proof.

To avoid this privacy risk, users of the trade proof should encrypt the data with a random 256 bit key and a fixed nonce specified in the trade proof embodiment. The reason for using a fixed nonce is that common ciphers used in cryptography variable nonces are so like AES_256 and CHACHA20 that encrypting the identical plaintext with the same key does not result in identical cipher texts. This is needed to mitigate chosen plaintext attacks. This defense is irrelevant in the case of a trade proof where the encryption process must be verifiable.

After encrypting the data, the cipher text is processed by a cryptographic hash to put in the data field of the trade proof.

### Verifying Proofs Against the Ledger

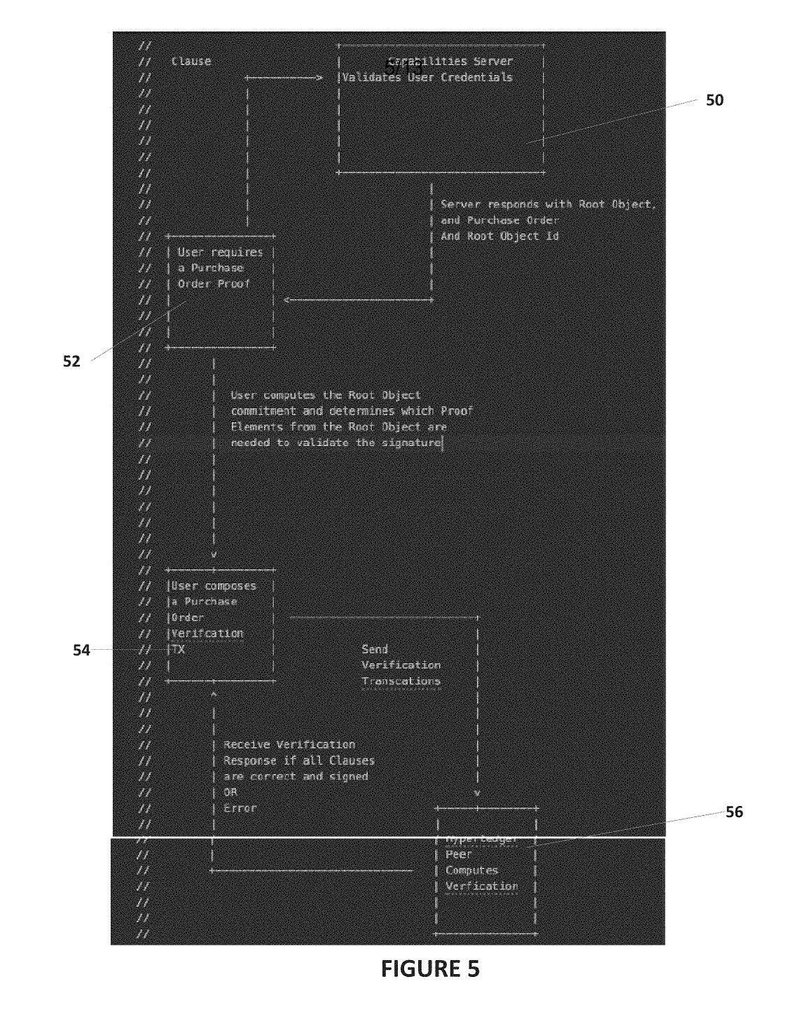

FIG. 5 is a verification diagram showing a request for a Root Object and Purchase Order according to the invention. Verification is done under a capabilities model. A User of the system who wishes to verify an Element Proof must obtain a set of capabilities from within the Shared Data Structure as shown in 52. From a capabilities server 50, the User first obtains a Root object which is a capability to know the names (identifiers) for all of the Proof Elements. The same system provides the user with an algorithm for generating a commitment.

The user generates a commitment from the root object 54. The root object contains a set of Element Proof IDs and their types, such as Amount, Description of Goods, etc. The user, through their granted capability, can obtain content for a subset of these Element Proofs and can then use the Element Proof in the Distributed Ledger to ascertain that the content they have received is authentic 56. These are used to construct TRecsVerify protocol buffer message and use the TRecsVerifyQuery transaction against the ledger.

### Example of Client Computation (See FIG. 5)

```
Response from Capabilities Server= {
    rootElementProofId = “43125678976”,
    commitment_alg =“sha256”,
    rootObject:[{id:“1341253”,title:“Delivery”},
    {id:“4659252345”,title:“Payment
    Terms”},{id:“1341253”,title:“Item list”}],
    [{title: “Payment Terms”}, data: binaryblob*]
Client computes sha256(rootObject)
Client computes sha256(data)
Client generates a
    TRecsVerify({43125678976,sha(rootObject)},
    [{4659252345,sha(data)}])
If the Proofs are valid the Query tx returns the json
    of the 43125678976 and 4659252345 elements
```

### Fiduciary Blockchain Code (FBC)

The representation of a Purchase Order and/or an Invoice on the blockchain can take many forms. However, for different parties to be able to trust and understand what these forms are, they need to be clearly identified on a well-publicized format. In previous technology iterations, EDI (Electronic Data Interchange), SWIFT MT (Message Types), and other similar mechanisms have been used to communicate documents between related parties. Documents, however, are static by nature, while trade is interactive and dynamic. Smart Contracts are uniquely capable of not only establishing the form of an instrument, but are also able to maintain their state securely on a blockchain. The term Fiduciary-Blockchain code (FBC) is used herein to denote Smart Contracts for these well-known trade instruments. By providing validation of documents through such Smart Contracts, one can trigger actions such as Interledger Transactions or Monetary transfers based on document state.

A purchase order FBC is a smart contract module that allows clients to Create, Modify, Finance, and perform related transactions in a secure manner on a distributed ledger that can be audited at any time during its life cycle by a third party, such as a potential financier. Similarly, an Invoice FBC is a smart contract module that allows clients to Create, Discount, Transfer, etc. securely on a blockchain/distributed ledger. Specifically, these actions are recorded on a permissioned distributed ledger where the validators for the ledger are given permission to participate. A reference implementation of these FBC smart contracts has been developed as ChainCode in the Linux Foundation HyperLedger.

One of the key requirements to be able to establish a valid interpretation of transactions recorded on a distributed ledger is cross validation of reconstructed state. By this is meant that transactions on a ledger by themselves have no obvious meaning. Software is needed to reconstruct system state, e.g. a document's current state, from these transactions. However, this introduces a dependency on the software doing the reconstruction. The ability to cross validate the reconstructed state, serves as a check that the software being used is correct. To provide this cross validation a commitment (hash) to the system state is included in the blockchain. This allows one to compare that hash of the reconstructed state against the hash in the blockchain to verify that the reconstruction is correct. In embodiments of the invention, the FBC has this feature in that it includes a commitment to the reconstructed state in the blockchain/distributed ledger and, hence, allows future reconstructions of document state to prove that they are correct.

### Blockchain/LC Hybrids

Embodiments of the invention provide a system that is a hybrid of electronic blockchain technology with the existing paper-based LC system, discussed above, which provides benefits to a bank that adopts the system, even when other banks in an LC transaction have not adopted it. This motivates early adopters and thus bootstraps the ecosystem. Moreover, when two banks who are parties to an LC transaction both use this system, they can operate in an all electronic manner without current paper-based LCs. In other words, once the system is deployed at a bank, it provides different levels of benefit in different LC transactions, depending on adoption status of counterparty banks, but only one deployment is needed at that bank.

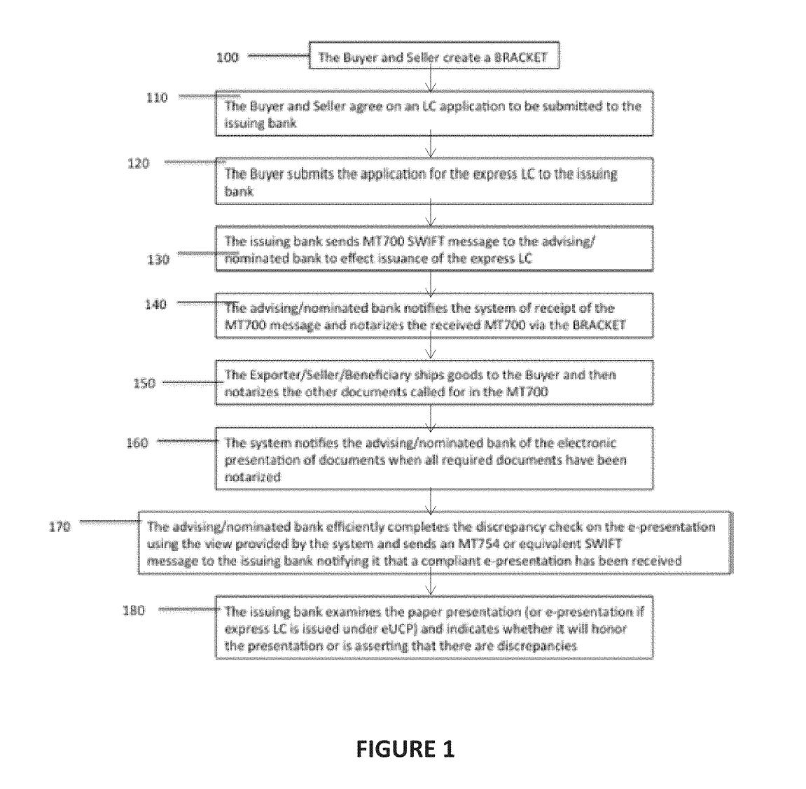

Each of the steps in the work flow is explained below (see FIG. 1):

1. The Buyer and Seller create an SDS (100) (a data structure that interfaces to the blockchain) on the Advising/Nominated bank's portal to define their agreement. This effectively includes a purchase order from the Buyer to the Seller specifying all relevant terms. The advising/nominated bank is blockchain/SDS-aware while the issuing bank is not. The issuing bank follows current LC processes as specified by ICC UCP 600.

2. The Buyer and Seller agree on an LC application to be submitted to the issuing bank (110). The system assists them in creating this LC application and includes the additional content required for express LCs in the appropriate part of the LC application. On reaching agreement they jointly notarize the LC application and then the Buyer receives a copy of it.

3. The Buyer submits the application for the express LC to the issuing bank (120).

4. The issuing bank sends an MT700 SWIFT message to the advising/nominated bank to effect issuance of the express LC (130).

5. The advising/nominated bank notifies the system of receipt of the MT700 message and notarizes the received MT700 via the SDS (140). Optionally, the advising/nominated bank authorizes the system to issue a SCRIP to be used by the exporter/seller/beneficiary to settle payments upstream in their supply chain.

6. The Exporter/Seller/Beneficiary ships goods to the Buyer and then notarizes the other documents called for in the MT700, such as the commercial invoice (150). At the same time other parties, such as the Insurer (insurance document) and Carrier/3PL (logistics/transport document), notarize documents they are responsible for using the SDS.

7. The system notifies the advising/nominated bank of the electronic presentation of documents when all required documents have been notarized (160).

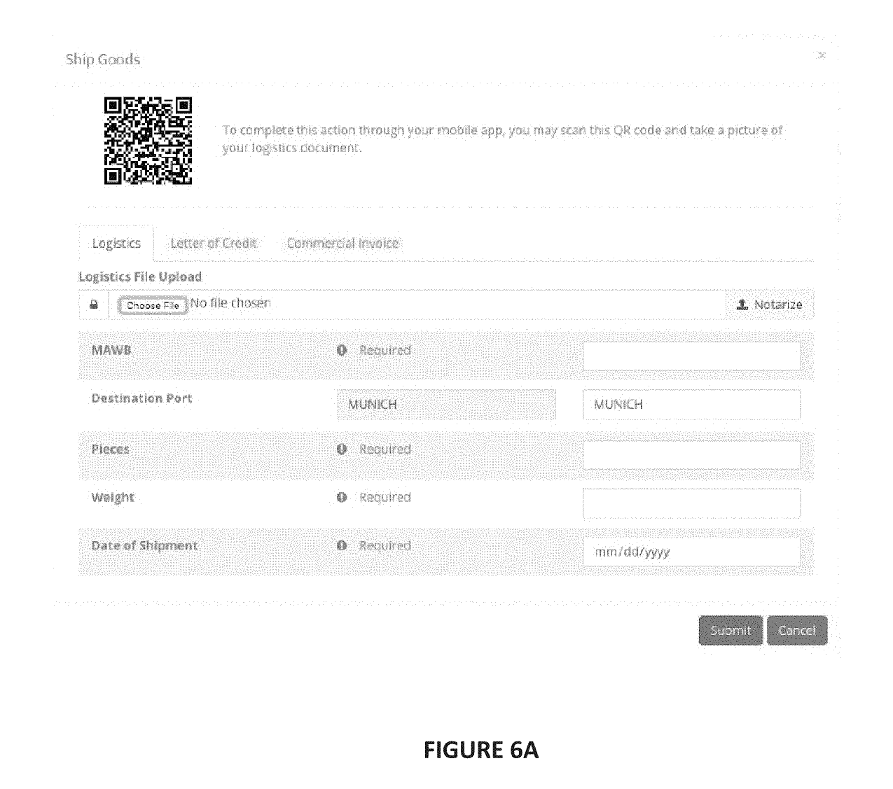

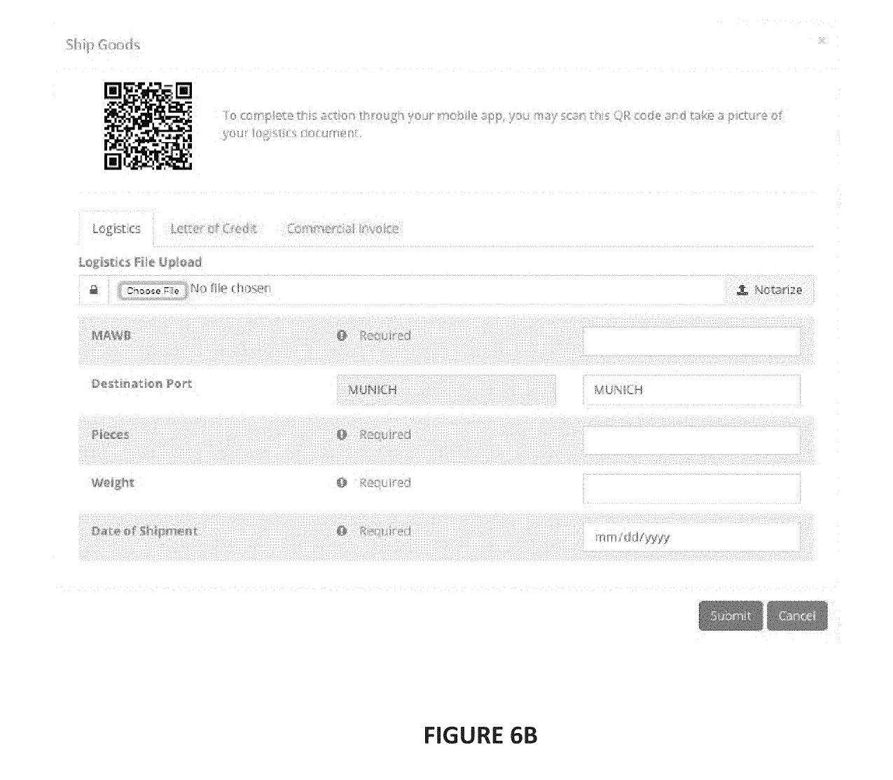

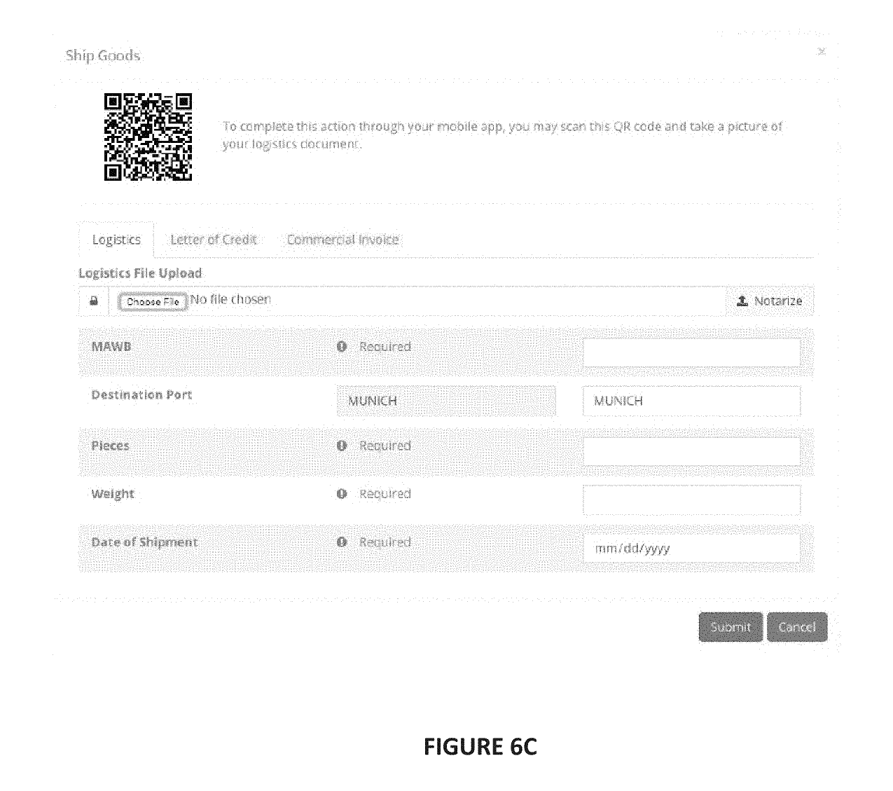

8. The advising/nominated bank efficiently completes a discrepancy check on the e-presentation using the view provided by the system and sends an MT754 or equivalent SWIFT message to the issuing bank, notifying it that a compliant e-presentation has been received (170). The advising/nominated bank sends paper documents via courier to the issuing bank. If the express LC is issued under eUCP, the courier for paper document is not needed, and the advising/nominated bank includes the e-presentation information in part 72 or 77A of the MT754 message. See FIGS. 6A-6C which show e-presentation logistics (FIG. 6A), a letter of credit (FIG. 6B), and a commercial invoice (FIG. 6C).

9. The issuing bank examines the paper presentation, or e-presentation if an express LC is issued under eUCP, and indicates whether it will honor the presentation or if it is asserting that there are discrepancies in the presentation (180).

One of the important benefits of this architecture is that it preserves a feature of current LCs system which protects participant rights, viz. that the check for discrepancies happens independently both at the seller's bank (nominated or advising bank) and at the buyer's bank (issuing bank). In contrast, the bank payment obligation (BPO) has only one centrally administered discrepancy checking stage (the SWIFT TSU) for which the input is entirely provided by the seller's bank. Such an architecture erodes the buyer's rights because there is no participant in the BPO checking stage looking out for the buyer.

At a bank, embodiments of the invention distinguish between two phases of deployment of the system. Phase 1 enables e-presentation and Phase 2 enables Straight Through Processing (STP). The discussion below describes the different levels of benefit, depending on the phase of deployment and the status of adoption by counterparties in an LC transaction.

### Semi-Electronic LC

In the case where an advising or nominated bank has deployed this system, but the issuing bank has not and is operating an unmodified paper based LC system, embodiments of the invention provide the following:

Electronic presentation from beneficiary/carrier/3PL to the nominated/advising bank. This requires that Phase 1 be implemented. This e-presentation provides convenience and shortens the time for the beneficiary to get paid, thus reducing their days sales outstanding (DSO) and improving cash flow. Heretofore, banks have selectively allowed their customers to e-present documents, often requiring time consuming prior legal agreements to ensure the security of the documents. The system herein disclosed incorporates requisite security and provides a simple and secure e-presentation solution that does not require time consuming setup for each customer.

### Express LC (AKA Data LC)

With the current conventions and protocols used in commercial LCs a discrepancy free, quick document review at the negotiating/advising bank is the critical step to ensuring that the beneficiary is paid quickly. Embodiments of the invention provide this as follows:

Spurious discrepancies which result from clerical errors or are not material can cause significant increase in processing time and the time to payment (DSO) for the beneficiary. Embodiments of the invention use a structured and simplified LC that defines the data fields to be checked to determine if a presentation is compliant. Such an LC is an express LC. Use of express LCs reduces spurious discrepancies when banks review documents. By avoiding spurious discrepancies and the attendant back and forth to get the discrepancies accepted, uncertainty in time to payment is significantly reduced and unnecessary costs for the beneficiary are avoided. Further, review time at the negotiating bank can be reduced because the discrepancy check for an express LC is reduced to a simple check on data fields. This increases the productivity of bank examiners and reduces the time to payment (DSO) for the beneficiary.

### STP at the Nominated/Issuing Bank for Express LCs

If Phase 2 has been implemented at nominated/advising bank then they can skip the human review for discrepancies and allow the system to provide straight through processing (STP) and take necessary actions. It is confidence in the security of the e-presentation provided by the system that opens the possibility of STP.

### Fully Electronic Solution

In the case where both the advising/nominated bank and the issuing bank have deployed the system, the following can be provided:

Direct electronic presentation to issuing bank. In embodiments of the invention, the system can seamlessly notify the issuing bank to review the e-presentation that the nominated/advising bank has received through the system and completed reviewing. This end-to-end e-presentation avoids the need for a courier to take paper documents from the nominated/advising bank to the issuing bank. In effect, the system serves as a definition of how e-presentation is to be done, which is left undefined in eUCP guidelines and has not yet been standardized.

### End-to-End STP for Express LCs

If a bank has implemented Phase 2, whether it is the nominated/advising bank or the issuing bank, it can avoid human review and have the electronic presentation for an express LC be subject to STP. If both banks have implemented Phase 2, this results in an End-to-End STP system for such LCs.

End-to-End STP for LCs with Complex Conditions

The system allows the definition of complex computable contracts to be encoded into LCs when all of the parties have adopted the system. Rather than simple data matching of field in specified documents, complex computable contracts can execute code on the presented data to decide if the presentation is compliant. For example, if shipped before date D, quantity X is acceptable, but if shipped after date D, then quantity greater than Y is necessary. Embodiments of the invention achieve STP for such complex contracts by having the LC reference the system as determining whether a presentation is compliant. The system, in turn, encodes the complex computable contract and defines the outcome of a presentation.

Embodiments of the invention represent an LC transaction with a data structure called an SDS which provides an interface to the underlying blockchains. A single transaction may be considered to consist of a pair (SDS, LC). The LC is a standard LC as used in the correspondent bank documentary credit system today. In embodiments, features of the invention that enable this hybrid Blockchain/LC to provide the functionality described above are as follows.

### Definition of an Express LC

An LC is issued by a bank sending a SWIFT MT700 to the advising bank. An express LC is a special case of an LC where the requirements that the LC places on the presentation are specified in a certain way and specific data is included in the MT700. The purpose of doing so is to make the discrepancy checking on the presentation amenable to automation/Straight Through Processing (STP). Alternatively, if the discrepancy check is done by a bank examiner, it is quicker and more error free than for a generic LC. The express LC avoids spurious discrepancies, thereby improving reliability and speed of delivery of the funds to the beneficiary.

One realization of an express LC uses part 47A (Additional Conditions) in the MT700 SWIFT message. Embodiments of the invention include field content in that part, such as discussed below, to define the data fields that must be checked.

The content may be seen as consisting of three parts:
A text section describing the discrepancy checking process;
An optional IssuingBankEphemeralPublicKey that can be used in the future to encrypt an e-presentation to the issuing bank; and
A JSON data structure defining the documents, the Signer Public Key for each document, which identifies the signatory needed for that document to be considered authentic and fields in those documents that need to be checked against the values provided. Certain of the values in the structure above may be unspecified. For example, the master airway bill (MAWB) value is not known at the time the MT700 message for LC issuance is sent, so it is be marked unspecified.

### MT700 Part 47A Content

All discrepancies except those pertaining to the fields in the documents below are waived. The authenticity of each document should be verified using the Signer Public Key for that document using the process specified in the ‘Express LC Best Practices’ document:

(Optional) IssuingBankEphemeralPublcKey
{
“IssuingBankEphemeralPubKey” : Value
“Letter of Credit”: {
“SignerPublic” : Value
“Fields” : {
“LC Number” : Value
“Latest Presentation Date” : Value
“Applicant Name” : Value
“Beneficiary Name” : Value
“Consign Top” : Value
“Notify” : Value
} }
“Commercial Invoice”: {
“Signer Public Key” : Value
“Fields” : {
“Description of Goods” : Value
“PO Number” : Value
“Inco Terms” : Value
“Payment Terms” : Value
“Invoice Number” : Value
“Invoice Value” : Value
“Claim (Draft) Value” : Value
} }
“Logistics”: {
“Signer Public Key” : Value
“Fields” : {
“MAWB” : Value
“Destination Port” : Value
“Pieces” : Value
“Weight” : Value
“Date of Shipment” : Value
} }
}

The part 47A content could be sent in other parts of the MT700 message, such as (72 or 77A), depending on how the express LC is standardized in the community.

### An Efficient Way to Issue Express LCs

Each bank has its own forms to issue LCs that the Buyer must fill out. Today, the Seller sometimes provides instructions to the Buyer indicating how they would like the LC to be issued. The Buyer is then responsible for using this information to fill out the LC application of their bank. This transcribing of LC instructions into the LC application is both a time consuming burden for the Buyer and error prone. The issued LC in the MT700 may still not meet the requirements that the seller specified, and the LC would then need to be amended in a costly and time consuming process. In the herein disclosed hybrid blockchain/LC system, it is necessary to work directly with the bank LC application and have the buyer and seller fill out the LC application and reach agreement on what the buyer is to submit to their bank. The agreement between buyer and seller on the LC application document is notarized (see below) using the SDS system to remove any future disputes in case the LC is not issued correctly. This process simplifies and removes errors and ensures that the express LC is issued in a way acceptable to seller and buyer and that no amendments are necessary.

### Notarization

Data LCs are notarized through the Trade Proof. Because the Data LC is a single static document, notarization can be done in a single Trade Proof. The Trade Proof contains a cryptographic commitment

### An Efficient Way for Document Examiners to Determine Compliance of an Express LC

The SDS data structure instance that represents a specific express LC transaction holds pointers to the notarization information of all the relevant documents that have been provided by participants. This allows the hybrid blockchain/LC system to offer a friction-free view to document examiners at banks, all in one place and with validated document integrity. This user interface for bank examiners simplifies and reduces the time they need to spend to collate and examine the documents, significantly increasing their productivity. Embodiments of the invention provide a user interface that allows bank document examiners to complete their examination in a few minutes in a reliable way, which today takes many hours to days because of the need to collate and double and triple check the documents carefully for compliance to the issued LC.

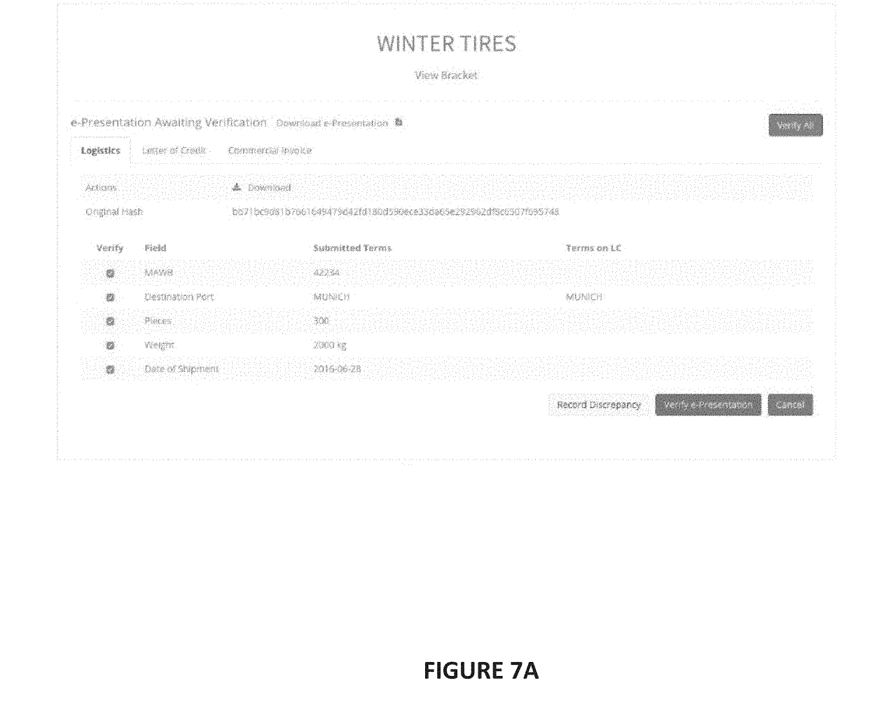

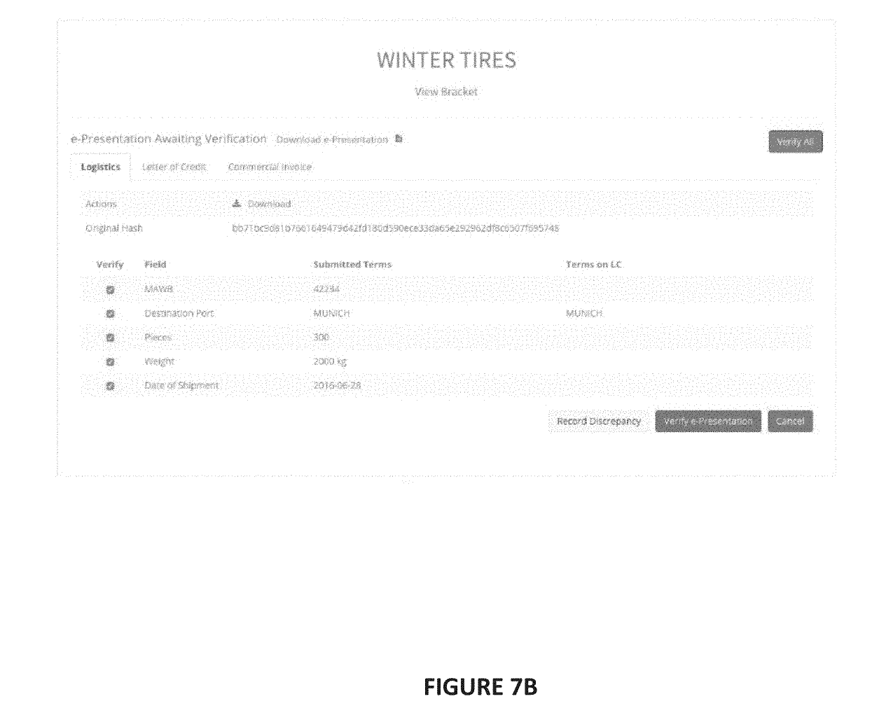

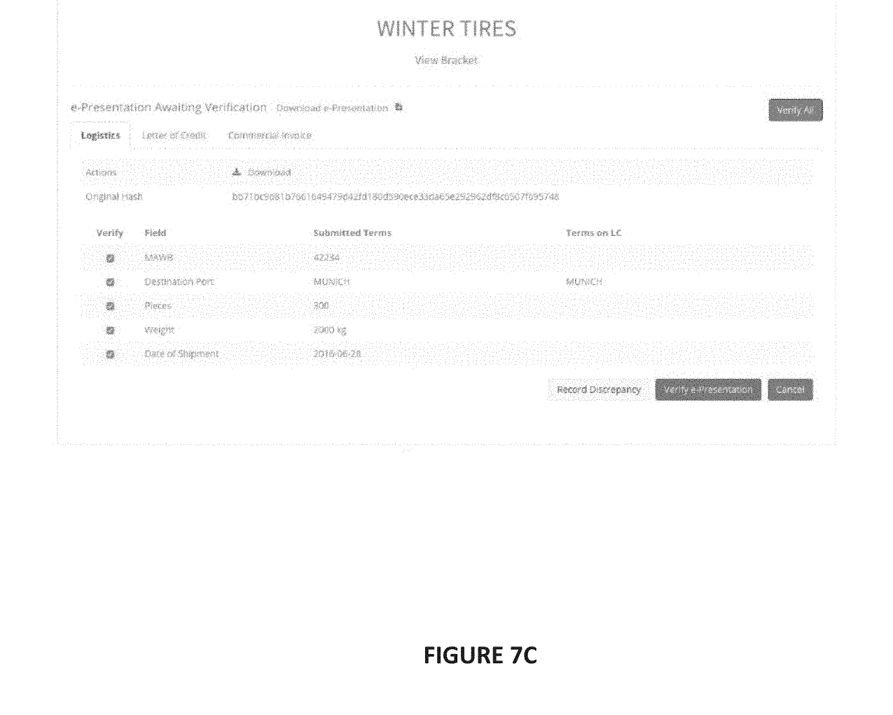

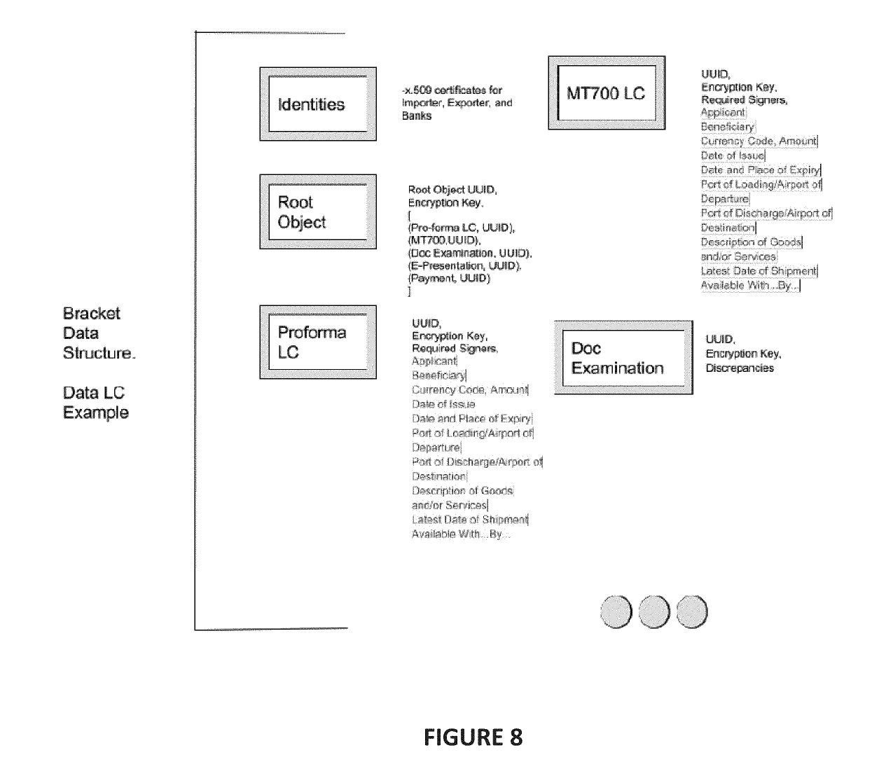

See FIGS. 7A-7C which show examination logistics (FIG. 7A), a letter of credit (FIG. 7B), and a commercial invoice (FIG. 7C); and FIG. 8, which shows a shared data structure (SDS) for a data LC.

FIG. 8 shows how the SDS is instantiated for the Data LC use case. The SDS is an evolving collaborative structure that is completed by each of the parties as the transaction proceeds. Access to this data structure is carefully controlled by the platform provider while the blockchain where the Trade Proofs are executed is treated as available to competitors. The SDS and ledger form inverses of each other. The SDS provides the capability to validate the Data LC process. The ledger provides proof of validity. The Root Object in the Data LC data structure contains the UUID and Field Names for all the pieces of data that are required for the end-to-end transaction. Each Individual Element in the SDS is completed as data becomes available and signed and notarized on the shared ledger. The UUID and encryption key values in the SDS provide the key information needed by all the parties to determine if the information in the SDS has been signed and is currently valid.

A Method for e-Presentation of Express LCs to an Issuing Bank that has not Adopted this System

If the issuing bank has issued the express LC under eUCP, i.e. has allowed for e-presentation of documents, but is not SDS-aware, i.e. it is not a user of the Hybrid Blockchain/LC system, one can yet accomplish efficient e-presentation to the issuing bank using the method described below.

When the advising/nominated bank has reviewed an e-presentation of an express LC and found it to be compliant, it would normally send a SWIFT MT754 message or equivalent to the issuing bank to indicate that presented documents are being forwarded. Embodiments of the invention provide a modification to such a SWIFT message to include the following additional content in for example part 72 or part 77A of the message:

MT754 or equivalent, part 72 or 77A content
(Optional) AdvisingBankEphemeralPublicKey
OptionallyEncrypted[{
“Letter of Credit”: {
“Document Link” : Value
“DocHash” : Value
“BlockchainTxID” : Value
“Nonce” : Value
“first_phase_nonce” : Value
“K” : Value
“Fields” : {
“LC Number” : Value
“Latest Presentation Date” : Value
“Applicant Name” : Value
“Beneficiary Name” : Value
“Consign To” : Value
“Notify” : Value
} }
“Commercial Invoice”: {
“Document Link” : Value
“DocHash” : Value
“BlockchainTxID” : Value
“Nonce” : Value
“first_phase_nonce” : Value
“K” : Value
“Fields” : {
“Description of Goods” : Value
“PO Number” : Value
“Inco Terms” : Value
“Payment Terms” : Value
“Invoice Number” : Value
“Invoice Value” : Value
“Claim (Draft) Value” : Value
} }
“Logistics”: {
“Document Link” : Value
“DocHash” : Value
“BlockchainTxID” : Value
“Nonce” : Value
“first_phase_nonce” : Value
“K” : Value
“Fields” : {
“MAWB” : Value
“Destination Port” : Value
“Pieces” : Value
“Weight” : Value
“Date of Shipment” : Value
} }
}]

### The Additional Content Consists of Two Sections:

The first (optional) section contains the AdvisingBankEphemeralPublicKey corresponding to the (optional) IssuingBankEphemeralPubKey in the MT700 message that issued the express LC. These two EphemeralPublicKeys allow the Advising/Nominated bank to encrypt the second section of the content that contains the e-presentation data. By using this end-to-end encryption the issuing and nominated banks ensure that no intermediary in the network can read the contents of the e-presentation, including the documents that are referred to therein. The mechanism of encryption uses Elliptic Curve Diffie Hellman to define a shared secret with the AdvisingBankEphemeralPublicKey and the IssuingBankEphemeralPublicKey.

This Diffie Hellman scheme can be made resilient to man-in-the-middle attacks by having the issuing and advising/nominated bank store the hash digest of the shared secret. These hashes can be arranged in time order as the leaves of a Merkle tree. The root of the Merkle tree can then be periodically compared. This has the further advantage of allowing the parties to prune the leaf nodes of the Merkle tree periodically if they compact the data they storing. If a man-in-the-middle was actively compromising their communication then the root would not match and the attack would be detected when the side-channel comparison is done. This detection mechanism should be a strong deterrent to doing a man-in-the-middle attack, because only SWIFT itself is capable of pulling off a man-in-the middle attack within the SWIFT network.

The second section (which is optionally encrypted) is a JSON data structure providing the following for each document that is specified as required in the MT700 express LC message:
Document Link: a link that the examiner at the issuing bank can use to fetch the document;
A Trade Proof for the document
Nonce: the nonce value used to compute the signature key pair from the Signer Public Key pair;
first_phase_nonce: the first phase nonce that initializes the blockchain notarization;
K: random private key used to encrypt the document; and
Fields: contain the values from the document of the Fields specified in the MT700.

This content in the MT754 allows the document examiner to fetch a document; compare the hash of the document to the hash notarized in the blockchain transaction, including first_phase_nonce, to ensure document integrity; validate that the transaction was signed with a key derived from the PrivateKey and Nonce, thus identifying the signer; optionally decrypt the document by deriving the document encryption key using the K value and Nonce; and then compute the hash of the unencrypted document to compare it against DocHash to reverify document integrity.

Once the document examiner knows that an authentic document is being viewed the document examiner can then check that the reported values in the Fields variable in the content match the values in the documents themselves. This is a quick and simple check. Then they can compare these verified Fields variables to the requirements on those document Fields specified in the MT700 message that issued the express LC. This is again a simple check. On completing these checks for each of the documents they can determine whether the presentation is compliant.

By using this method of e-presentation the issuing bank is assured of a secure e-presentation which is the primary consideration that has held back issuance of LCs under eUCP, i.e. allowing e-presentation. Moreover, by standardizing and creating a generally accepted method embodiments of the invention remove the burden on the issuing bank to determine a secure scheme for e-presentation that is acceptable to other banks.

### Issuance of SCRIP to Allow Beneficiaries to Settle Supply Chain Obligations

SCRIP is a cryptographically tracked short term bearer debt instrument maintained by the system. It has validity only internal to the system. It facilitates settlement of obligations between suppliers who all participate in the system. SCRIP is an obligation to pay a certain amount on a certain date. The Advising/Nominated bank can authorize issuance of SCRIP, generally some fraction of the total amount due to the exporter/seller/beneficiary. The SCRIP can be cashed on the due date, i.e. the day the LC specifies payment is due to the beneficiary. The exporter/seller/beneficiary can, in turn, pay suppliers with SCRIP, who in turn can pay their suppliers with SCRIP. One value of the system lies in the fact that these upstream suppliers are cash flow constrained and usually face a high cost of capital. They are motivated to cash their SCRIP at a discount before the due date. This allows the advising/nominated bank to engage in financing transactions of the upstream suppliers by providing discounted early cashing of SCRIP without directly having to evaluate the credit worthiness of the upstream suppliers because the advising/nominated bank is made whole by LC that has been issued.

STP for LCs with Complex Conditions

So far, express LCs have been considered, where the values of certain document fields were defined in the MT700 message issuing the express LC. Embodiments of the invention support more complex conditions on the presentation than simple data matching of fields. For example, if shipped before date D, quantity X is acceptable, but if shipped after date D then quantity greater than Y is necessary. Embodiments of the invention achieve STP for such complex contracts by having the issued LC state that the hybrid blockchain (SDS)/LC system is the authoritative determinant of compliance of a presentation. The system, in turn, encodes the requirements in the LC as a computable contract in the form of a Boolean function. This Boolean function takes the data in the presented documents as input and outputs true or false depending on whether the presentation is compliant or not. Because the compliance is determined by the system, the advising/nominated and issuing bank can achieve automation, i.e. STP, even for such complex LCs.

### Computer Implementation

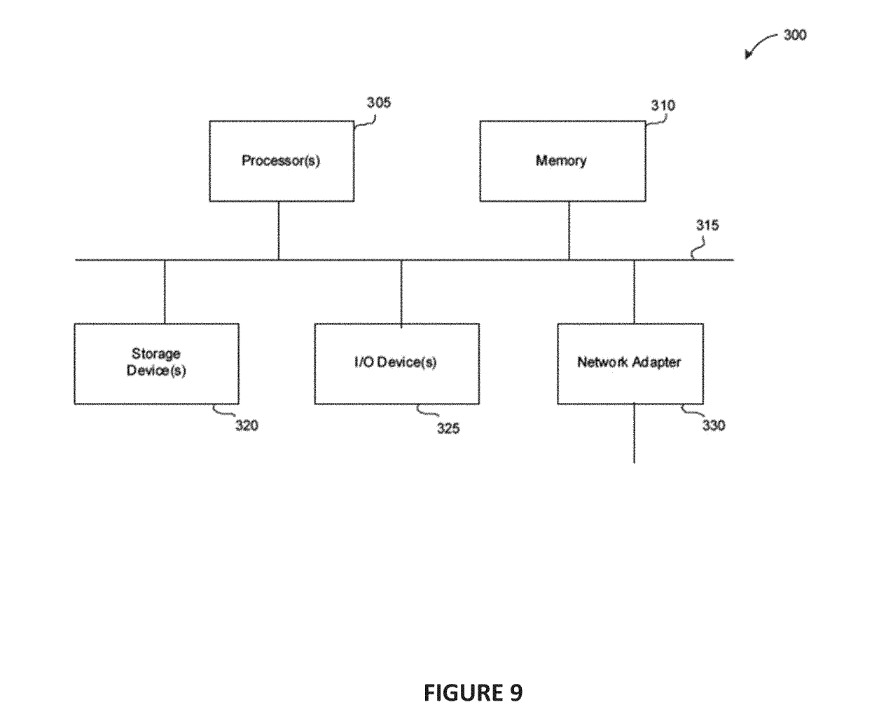

FIG. 9 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions, sequential or otherwise, that specify actions to be taken by that machine.

The computing system 300 may include one or more central processing units (processors) 305, memory 310, input/output devices 325, e.g. keyboard and pointing devices, touch devices, display devices, storage devices 320, e.g. disk drives, and network adapters 330, e.g. network interfaces, that are connected to an interconnect 315. The interconnect 315 is illustrated as an abstraction that represents any one or more separate physical buses, point to point connections, or both connected by appropriate bridges, adapters, or controllers. The interconnect 315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 310 and storage devices 320 are computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media. The instructions stored in memory 310 can be implemented as software and/or firmware to program the processor 305 to carry out actions described above. In some embodiments, such software or firmware may be initially provided to the processing system 300 by downloading it from a remote system through the computing system 300, e.g. via network adapter 330. The various embodiments introduced herein can be implemented by, for example, programmable circuitry, e.g. one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for securing a credit transaction (LC), comprising:
a processor representing an LC transaction with a shared data structure (SDS);
said SDS providing an interface to one or more underlying blockchains;
wherein a single transaction consists of a pair (SDS, LC);
said SDS representing a specific LC transaction holding pointers to notarization information of all relevant documents that have been provided by participants to the credit transaction.

2. The method of claim 1, further comprising:
said processor using part 47A (Additional Conditions) in a MT700 SWIFT message to create an express LC by including field content in said part 47A (Additional Conditions) in a MT700 SWIFT message to define data fields that must be checked, said field content comprising:
a text section describing a discrepancy checking process;
an optional IssuingBankEphemeralPublicKey for encrypting an e-presentation of said express LC to an issuing bank; and
a JSON data structure defining one or more documents, a SignerPublicKey for each document which identifies a signatory needed for that document to be considered authentic, and fields in those documents that need to be checked against values provided.

3. A computer implemented method for facilitating automated compliance for complex contracts between participants who have not developed a prior trust relationship, comprising:
a processor using a blockchain in financial transactions involving one or more instruments to ensure that ownership and title of said instruments are securely registered on a distributed ledger;
with said blockchain said processor providing:
tamper proof notarization to attest to authenticity and integrity of declarations by participants and proof of non-existence of such declarations;
cryptographic identifiers for goods or physical assets and authoritative title records maintained in the blockchain to guarantee consistency of title history and ensure that there is a unique title holder at any given point in time; and
cryptographic identifiers for items to hold item origin and history of custody in a way that allows sub-division and combination of items.

4. The method of claim 3, further comprising:
said processor creating a shared data structure (SDS) (blockchain/SDS) that interfaces to said blockchain on an advising/nominated bank's portal to define an agreement between a buyer and a seller, said SDS including a purchase order from the buyer to the seller specifying all relevant terms;
responsive to said buyer and seller agreeing on a credit (LC) application to be submitted to an issuing bank and, on reaching agreement, jointly notarizing the LC application, wherein the buyer receives a copy of application and said buyer submitting the LC application to the issuing bank; and said issuing bank sending an MT700 SWIFT message to the advising/nominated bank to effect issuance of LC, said processor receiving notification of receipt of an MT700 message from said advising/nominated bank, said received MT700 message notarized by said advising/nominated bank via the SDS data structure; and
said processor notifying the advising/nominated bank of electronic presentation of documents when all required documents have been notarized.

5. The method of claim 4, further comprising:
said processor receiving authorization from said advising/nominated bank to issue a SCRIP to be used by an exporter/seller/beneficiary to settle payments upstream in their supply chain.

6. The method of claim 3, further comprising any of:
the advising/nominated bank being blockchain/SDS-aware, while an issuing bank is not and is operating an unmodified paper-based LC system; and
the advising/nominated bank and an issuing bank both being blockchain/SDS-aware, wherein straight through processing (STP) is provided for electronic presentation of documents.

7. The method of claim 3, further comprising:
providing an end-to-end straight through process, said processor encoding a definition of complex computable contracts into LCs in the form of a Boolean function that takes data in presented documents as input and outputs true or false depending on whether the presentation is compliant or not.

8. The method of claim 3, further comprising any of:
the buyer and seller notarizing the agreement using the SDS to remove any future disputes in case the LC is not issued correctly; and:
the buyer and seller notarizing all documents with an attestation that a document is authentic, together with a timestamp indicating when the attestation was made to facilitate e-presentation of said documents to the nominated/advising bank.

9. The method of claim 8, further comprising:
the buyer and seller notarizing a digital document by creating a blockchain transaction by:
maintaining a publicly viewable record of a PublicKeys used by participants, where PublicKeys are a public key in a (PublicKey, PrivateKey) elliptic curve cryptography key pair, and from the SDS generating a Nonce and deriving a new key PublicKey(N) and Signature that is verifiable with that key.
if a signature with is presented together with the Nonce N, then a verifier with knowledge of the signer's PublictKey deriving PublicKey(N) to check that it is equal to the public key used in the signature;
wherein a verifier has then established that the signer had knowledge of the signer's PrivateKey, thus establishing the identity of a person who created the signature.

10. The method of claim 9, further comprising:
using derived key pairs (PublicKey(N), PrivateKey(N)) to create signatures to restrict linkability of signatures from a same PublicKey to only parties with authorized access to the SDS data structure.

11. The method of claim 4, further comprising:
encrypting a document D with a random private key K and a fixed nonce N for all LC users;
wherein encryption is performed with a stream-cipher or block-cypher operating in a stream mode to produce E(K,N,D); and
wherein a signature then signs a contribution from a cryptographic digest H(E(K,N,D)).

12. The method of claim 3, further comprising:
a blockchain transaction notarizing documents as a two phase commitment:
a first phase initializing the commitment with derived keys of one or more parties and a unique first_phase_nonce; and
a second phase signing a notarization with HDPrivateKey(N) to create a notarization for the document D.

13. The method of claim 4, further comprising:
accomplishing e-presentation to the issuing bank when the issuing bank has issued the LC and allowed for e-presentation of documents, but is not aware of the SDS, by modifying a SWIFT MT754 message or equivalent to the issuing bank to indicate that presented documents are being forwarded by including additional content in part 72 or part 77A of the message.

14. The method of claim 13, said additional content comprising any of:
a first section containing an AdvisingBankEphemeralPublicKey corresponding to an IssuingBankEphemeralPubKey in the MT700 message that issued the LC, wherein said two EphemeralPublicKeys allow the advising/nominated bank to encrypt a second section of the content that contains e-presentation data, and wherein said encryption uses Elliptic Curve Diffie Hellman to define a shared secret with the AdvisingBankEphemeralPublicKey and the IssuingBankEphemeralPublicKey; and
a second section which is optionally encrypted, said second section comprising:
a JSON data structure providing in the MT700 LC message a document link that an examiner at the issuing bank can use to fetch the document;
a hash of the plain document without encryption;
a blockchain transaction ID that references a transaction that notarized the document;
a nonce value used to compute a signature key pair from the Signer Public Key pair;
a first_phase_nonce that initializes blockchain notarization;
a random private key used to encrypt the document; and
fields that contain values from the document of the fields specified in the MT700 message.

15. The method of claim 14, further comprising:
using content in the MT754 message to allow a document examiner to fetch a document;
comparing a hash of the document to a hash notarized in the blockchain transaction, including the first_phase_nonce, to ensure document integrity;
validating that the transaction was signed with a key derived from the Public Key and nonce to identify the signer;
optionally decrypting the document by deriving a document encryption key using the K value and nonce; and
computing a hash of the unencrypted document to compare it against a document hash to reverify document integrity.

16. A method for maintaining a shared data structure, comprising:
recording terms of a trade transaction in a shared data structure (SDS) comprising a hybrid of a blockchain and a shared information system that defines and maintains shared contract state across parties and that integrates commercial documents used by transaction parties;
said SDS recording performance by parties against agreed upon terms and automatically executing a flow of money based upon signals resulting from a flow of goods; and
said SDS maintaining shared information across the commercial parties in the transaction.

17. The method of claim 16, further comprising:
said processor creating said shared data structure (SDS) (blockchain/SDS), said SDS interfacing to said blockchain on an advising/nominated bank's portal to define an agreement between a buyer and a seller, said SDS including a purchase order from the buyer to the seller specifying all relevant terms;
providing a cryptographically tracked short term bearer debt instrument comprising an obligation to pay a certain amount on a certain date (SCRIP) to facilitate settlement of obligations between parties to a transaction;
wherein said advising/nominated bank can authorize issuance of SCRIP comprising a fraction of a total amount due to an exporter/seller/beneficiary;
wherein the exporter/seller/beneficiary, in turn, pays suppliers with SCRIP, who, in turn, pay their suppliers with SCRIP; and
wherein the advising/nominated bank can engage in financing transactions of a deep tier upstream supplier by providing discounted early cashing of SCRIP, without directly having to evaluate the credit worthiness of the preceding upstream supplier.

18. The method of claim 17, further comprising:
responsive to said buyer and seller agreeing on a credit (LC) application to be submitted to an issuing bank and, on reaching agreement, jointly notarizing the LC application, wherein the buyer receives a copy of application and said buyer submitting the LC application to the issuing bank; and said issuing bank sending an MT700 SWIFT message to the advising/nominated bank to effect issuance of LC, said processor receiving notification of receipt of an MT700 message from said advising/nominated bank, said received MT700 message notarized by said advising/nominated bank via the SDS data structure; and
said processor notifying the advising/nominated bank of electronic presentation of documents when all required documents have been notarized;
wherein the SCRIP can be cashed on the date that an LC specifies payment is due to a beneficiary.

19. The method of claim 16, comprising:
said processor managing commercial documents using notarization functionality provided by a distributed ledger/blockchain to generate independently verifiable proof that an invoice or purchase order is a valid receivable asset;
representing a document as consisting of elements;
recording assent to the elements by one or more parties using a cryptographic commitment element proof (EP) recorded on a distributed ledger/blockchain;
allowing elements to be revoked or superseded by the parties that are attesting to a document;
providing element content to be shared; and
pointing to a corresponding EP to provide authentication of content that has been shared.

20. The method of claim 19, further comprising:
providing any of:
a purchase order fiduciary blockchain code (FBC) for actions of creating, modifying, financing, and performing related transactions in a secure manner on a blockchain/distributed ledger that can be audited at any time during its life cycle by a third party; and
an invoice FBC for actions of creating, discounting, and transferring securely on a blockchain/distributed ledger; and
recording said actions on a permissioned distributed ledger.

21. The method of claim 19, further comprising:
cross validating reconstructed state by including a commitment (hash) to system state in the blockchain to compare a hash of the reconstructed state against the hash in the blockchain and verify that the reconstruction is correct.

22. The method of claim 21, further comprising:
providing a commitment to the reconstructed state in the blockchain/distributed ledger to allow future reconstructions of document state to prove that they are correct.

23. The method of claim 19, further comprising:
using one or more cryptographic commitments to data held on other systems, said cryptographic commitments hiding information committed to and binding to that information, wherein only original information stored in said other systems can satisfy a commitment;
providing one or more documents, each document consisting of document elements;
wherein a commitment to a document consisting of such elements is made up of distinct element proofs (EPs) inside a distributed ledger;
providing a purchase order document proof including a document root, a head element, and one or more EPs; and
when a modification is sent, a set of transactions introducing a superseding proof element into the ledger.

24. The method of claim 23, further comprising:
introducing a new proof element in to a purchase order proof; and
updating the head element to include a commitment to the new proof element.

25. The method of claim 24, further comprising:
obtaining a set of capabilities to verify an EP by obtaining a root object having a capability to know the names (identifiers) for all of the EPs;
generating a commitment from the root object, the root object containing a set of EP IDs and their types;
through their granted capability, obtaining content for a subset of the EPs; and
using the EP in the distributed ledger to ascertain that the content they have received is authentic.

26. A method for preventing unauthorized parties from using publicly available blockchain data to infer commercially relevant information, comprising:
maintaining a publicly viewable record of a long term identity key for a particular entity, wherein said identity key is signed by a certificate authority to provide a connection to a real world identity;
providing a distributed public ledger on which public keys used are computationally unlinkable to identities used on the blockchain to create two categories of users of the blockchain;
wherein a first category comprises users that have access to a shared data structure (SDS) and can link signatures on the ledger to publicly observable identities; and
wherein a second category comprises users who only have access to a public ledger and cannot link identities to signatures on the ledger.

27. The method of claim 26, further comprising:
providing said identity key as a public key in a (PublicKey, PrivateKey) elliptic curve cryptography key pair;
an authentic holder of the identity key generating a set of signatures that is only linkable to the holder's keypair through knowledge of a nonce, N;
a signer generating a new PublicKeyN using PublicKey.Derive(N) to generate a signature and then performing Sign(PrivateKey, N, message);
publishing the PublicKeyN and the signature, wherein the nonce cannot be feasibly computed from published data;
a verifier who wishes to link the identity first verifying the signature with verifySig(PublicKeyN,signature,message); and
the verifier obtaining the nonce N from the SDS data structure and verifying that PublicKeyN=PublicKey.Derive(N).

28. The method of claim 26, further comprising:
said SDS containing a UUID for each element of a plurality of individual elements;
wherein all parties required to assent to a field of a document have a unique unlinkable public key derived for a trade proof;
generating said public keys by taking a hash of the UUID and treating a resulting output as an N bit integer;
multiplying the integer by a base point of an elliptic curve chosen by an SDS-based protocol;
adding a resulting elliptic curve point to public keys of each of signatories to create a unique identity bound to a trade proof for an element of the SDS;
each signatory transforming their Private Key when each signatory signs the trade proof by taking the hash of UUID as an integer, performing modular arithmetic with their private key, and then running a standard elliptic curve signature algorithm with a sum of these two values.

29. The method of claim 28, further comprising:
generating SDS nonces by cryptographically hashing (Sha256) the UUID values with the SDS.

30. The method of claim 28, further comprising:
providing parties to a transaction with access to the SDS, including all of the UUIDs for each ledger entry; and
the parties linking the signatures used in the ledger to both certificated identities and to a specific element identified by a UUID in the SDS.
